(19) United States
(12) Patent Application Publication
(10) Pub. No.: US 2016/0340972 A1
(43) Pub. Date: Nov. 24, 2016

(54) SUN-SHADING ADJUSTMENT STRUCTURE OF ZEBRA SHADE

(71) Applicant: Tser Wen CHOU, Yorba Linda, CA (US)

(72) Inventor: Tser Wen CHOU, Yorba Linda, CA (US)

(21) Appl. No.: 15/227,678

(22) Filed: Aug. 3, 2016

Related U.S. Application Data
(63) Continuation-in-part of application No. 14/693,849, filed on Apr. 22, 2015.

(51) Int. Cl. E06B 9/17; E06B 9/78; E06B 9/68

(52) U.S. Cl. CPC E06B 9/17023; E06B 9/68; E06B 9/78; E06B 2009/785

(57) ABSTRACT

A sun-shading adjustment structure of zebra shade includes a shade sheet winding unit, a shade sheet adjustment unit, a shade component fixing unit, a support unit, a decorative board locating unit and a lower weight unit. The shade component fixing unit is mounted under upper wall face on inner side of a window. The shade sheet winding unit and the shade sheet adjustment unit are back and forth side by side arranged under the shade component fixing unit. The support unit serves to support the shade sheet adjustment unit and keep it straight. When the shade sheet is wound up by the shade sheet winding unit, in the case that a gap exists on the shade sheet to allow sunlight to get in, the shade sheet adjustment unit is used to adjust the alignment error of the transparent faces and the nontransparent faces of the shade sheet so as to eliminate the gap.

### BACKGROUND OF THE INVENTION

1. Field of the Invention

The present invention relates generally to a sun-shading adjustment structure of zebra shade, and more particularly to a sun-shading adjustment structure of zebra shade, which includes a shade sheet adjustment unit for adjusting the alignment error of the transparent faces and the nontransparent faces of the zebra shade sheet. Therefore, in the case that a gap exists on the zebra shade sheet to allow sunlight to get in, by means of the shade sheet adjustment unit, the gap can be eliminated to enhance the sun-shading effect.

2. Description of the Related Art

The shade sheet of a conventional zebra shade has nontransparent faces and transparent faces. The nontransparent faces and transparent faces are alternately arranged to shade the sunlight. The zebra shade is installed in such a manner that one end of the shade sheet is located on a shade sheet winding unit. Then the shade sheet is wound over a lower weight to affix the other end of the shade sheet onto a shade component fixing unit. When it is desired to have sunlight project into the room, the shade sheet is wound up by the shade sheet winding unit to align the transparent faces with each other. Under such circumstance, the sunlight can pass through the two transparent faces into the room as a light source. Alternatively, the shade sheet can be wound up to the topmost end, permitting the sunlight to fully project into the room. In contrast, when it is desired to shade the sunlight, the shade sheet is unwound and released downward. When the nontransparent faces are horizontally aligned with the transparent faces, the shade sheet becomes in a totally nontransparent state. At this time, the sunlight is interrupted by the nontransparent faces from getting into the room so as to achieve a sun-shading effect. The shade sheet is wound/unwound by the shade sheet winding unit. The roller of the shade sheet winding unit is controlled and driven by a bead chain to rotate. During the winding process, the nontransparent faces and the transparent faces must be totally aligned with each other so as to achieve the sunlight shading effect. However, it is hard to adjust the shade sheet by small angle so as to eliminate the gaps existing on the shade sheet, which permit the sunlight to get into the room. Therefore, the conventional zebra shade can hardly fully shade the sunlight and the sunlight can still partially get into the room. This needs to be improved.

### SUMMARY OF THE INVENTION

It is therefore a primary object of the present invention to provide a sun-shading adjustment structure of zebra shade, which includes a shade sheet adjustment unit. The shade sheet adjustment unit can be used to adjust the relative angle between the transparent faces and the nontransparent faces of the zebra shade sheet. Therefore, in use of the zebra shade, in the case that gaps exist on the zebra shade sheet to allow sunlight to get in, by means of the shade sheet adjustment unit, the gap can be eliminated to enhance the sun-shading effect. Moreover, the sun-shading adjustment structure of zebra shade includes a support unit for holding and supporting the shade sheet adjustment unit and keeping the shade sheet adjustment unit in a straight state. Accordingly, the adjustment can be more precisely performed.

To achieve the above and other objects, the sun-shading adjustment structure of zebra shade of the present invention includes:

a component fixing unit disposed on an upper wall face of inner side of a window, the component fixing unit including more than one fixing board, the fixing board having a front end and a rear end, the front end or the rear end of the fixing board being formed with engagement teeth;

a decorative board locating unit including more than one connection seat, the connection seat including a chucking mouth for engaging with the engagement teeth of the fixing board of the component fixing unit and an engagement board for connecting with a decorative board;

a shade sheet winding unit including two holders disposed on two sides of the fixing board and a roller mounted between the two holders;

a shade sheet adjustment unit including two locating seats disposed on two sides of the fixing board, the locating seats being positioned at the front end of the shade sheet winding unit or the rear end thereof, the volume of the locating seats being slightly smaller than the volume of the holders of the shade sheet winding unit, a roller being mounted between the two locating seats, the roller being driven by a bead chain controller to rotate;

a shade sheet having transparent faces and nontransparent faces, which are alternately arranged, one end of the shade sheet being connected to the roller of the shade sheet winding unit and the other end of the shade sheet being connected to the roller of the shade sheet adjustment unit;

a lower weight unit including a main body, a drive shaft, two sleeves and two side caps, the shade sheet being wound over the drive shaft, the sleeves serving to locate the drive shaft and being drivingly rotatably connected with the drive shaft, the two side caps being connected with the sleeves and capped on two sides of the main body; and

a support unit including an engagement body at upper end and an arched recess downward extending from the engagement body, the roller of the shade sheet adjustment unit being rotatably positioned in the arched recess.

Accordingly, the shade sheet winding unit serves to wind up the shade sheet to align the transparent faces and the nontransparent faces of the shade sheet with each other or misalign the transparent faces and the nontransparent faces of the shade sheet from each other so as to achieve a sun-shading effect. In addition, the shade sheet adjustment unit is further used to adjust the alignment error of the transparent faces and the nontransparent faces of the shade sheet so as to eliminate the gaps between the nontransparent faces and enhance the sun-shading effect.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the present invention;

FIG. 3 is a perspective exploded view of the shade sheet adjustment unit of the present invention;

FIG. 4 is a perspective assembled view of the shade sheet adjustment unit of the present invention;

FIG. 5 is a perspective view of the support unit of the present invention;

FIG. 6 is a perspective view showing the installation of the support unit of the present invention;

FIG. 7 is a perspective view showing the installation of the shade sheet of the present invention;

FIG. 8 is a perspective exploded view of the lower weight unit of the present invention;

FIG. 9 is a perspective view showing that the lower weight unit of the present invention is to be enclosed by a shade sheet fabric;

FIG. 10 is a perspective view showing that the lower weight unit of the present invention is enclosed by the shade sheet fabric;

FIG. 11 is a sectional view of the lower weight unit of the present invention;

FIG. 12 is a plane assembled view of the present invention;

FIG. 13 is a plane view showing the installation of the present invention;

FIG. 14 is a plane view showing that gaps exist on the shade sheet of the present invention;

FIG. 15 is a plane view showing that the shade sheet adjustment unit of the present invention is used to eliminate the gaps;

FIG. 16 shows the installation of the present invention in another aspect; and

FIG. 17 is a plane view of another embodiment of the present invention.

### DETAILED DESCRIPTION OF THE PREFERRED EMBODIMENTS

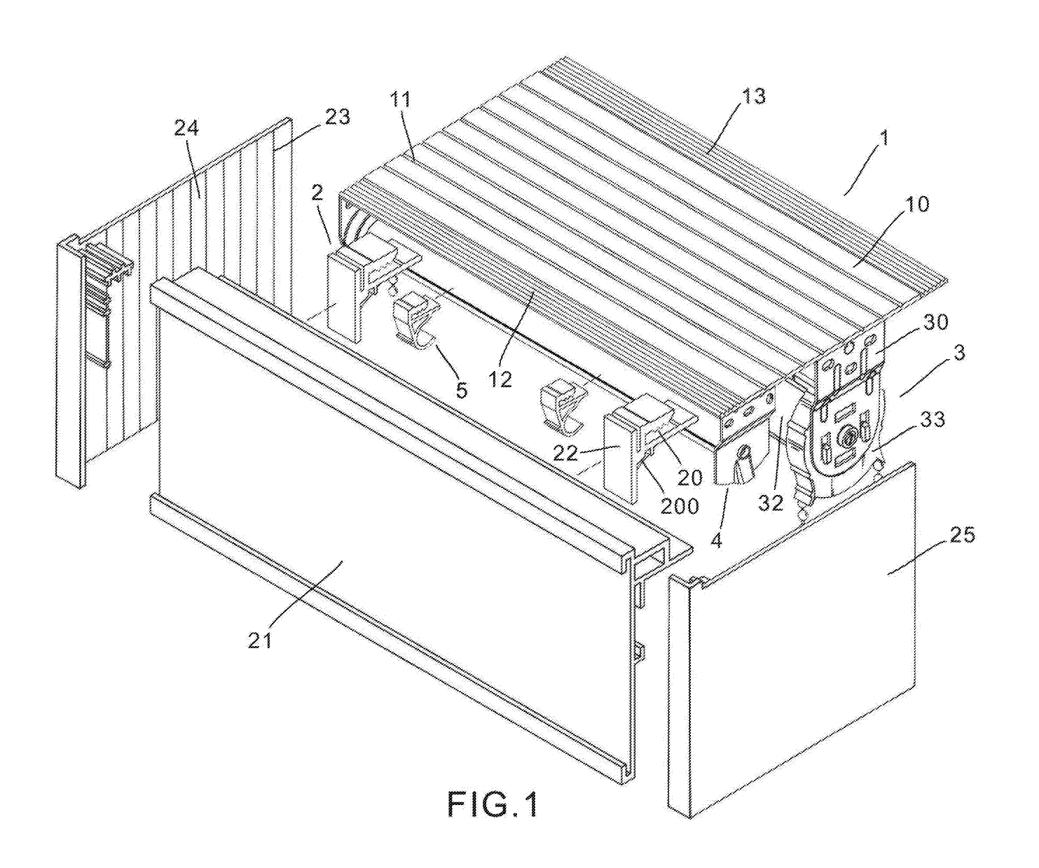

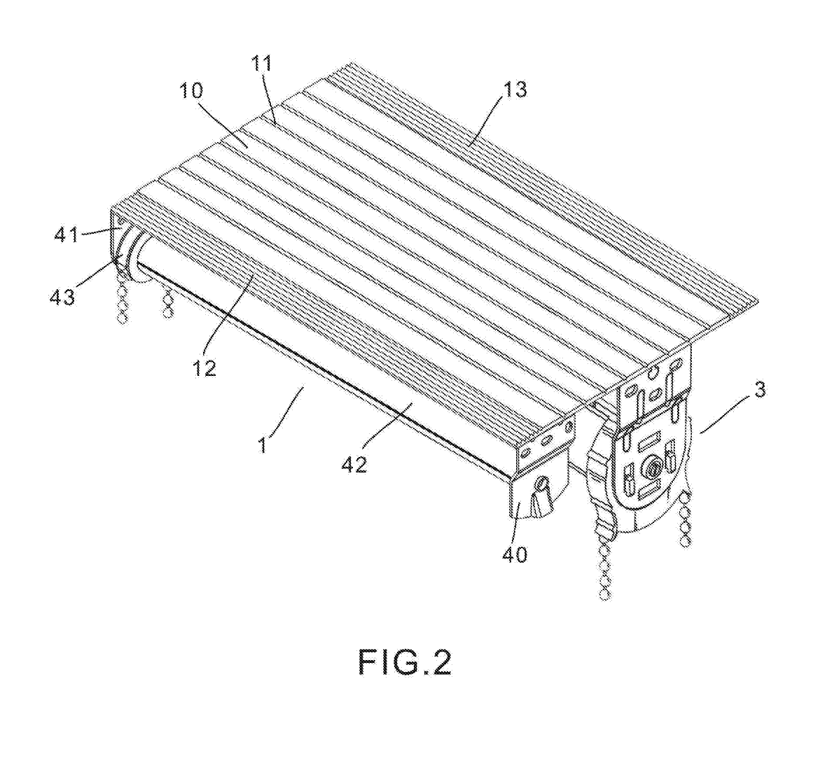

Please refer to FIG. 1. The present invention includes a component fixing unit 1, a decorative board locating unit 2, a shade sheet winding unit 3, a shade sheet adjustment unit 4, a support unit 5, a shade sheet 6 connected with the shade sheet winding unit 3 and the shade sheet adjustment unit 4, and a lower weight unit 7 for the shade sheet 6 to wind over and connect therewith. The component fixing unit 1 (as shown in FIGS. 1 and 2) includes more than one fixing board 10. The fixing board 10 is formed with break lines 11 for cutting the fixing board 10. The front and rear ends of the fixing board 10 are formed with engagement teeth 12, 13. By means of fixing members, the fixing board 10 can be mounted under the upper wall face on inner side of a window with the engagement teeth 12 of one end extending and protruding therefrom.

The decorative board locating unit 2 (as shown in FIG. 1) has a connection seat 200. The connection seat 200 includes a chucking mouth 20 for engaging with the engagement teeth 12 of one end of the fixing board 10 of the component fixing unit 10 and an engagement board 22 for connecting with a decorative board 21. Accordingly, the decorative board 21 can be engaged and connected to the edge of upper side of the window. Two cover boards 24, 25 formed with break lines 23 are fitted on two sides of the decorative board 21.

The shade sheet winding unit 3 (as shown in FIGS. 1 and 2) includes two holders 30 disposed on two sides of the fixing board 10 of the component fixing unit 1 and a roller 32 mounted between the two holders 30. The roller 32 is controlled by a bead chain controller 33 to rotate. One end of the shade sheet is affixed to the outer circumference of the roller 32, whereby the shade sheet 32 is controlled by the roller 32 to wind/unwind and move up and down.

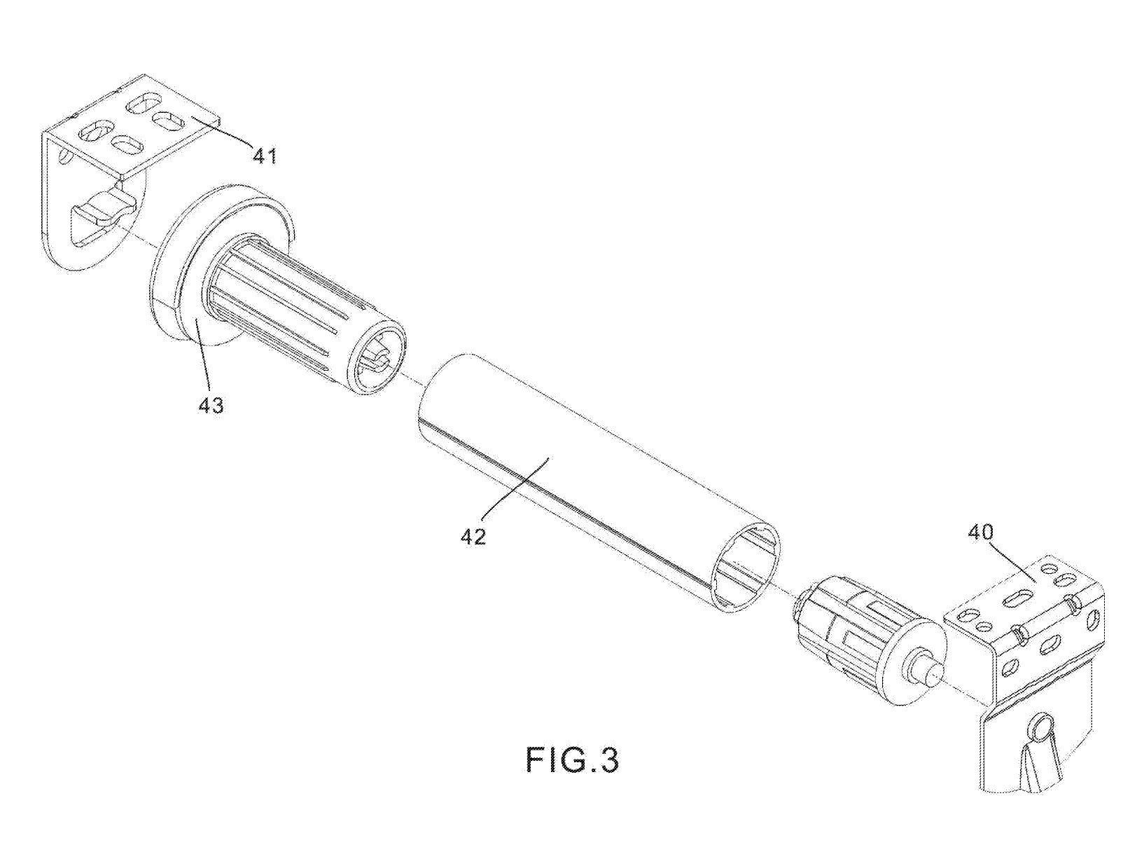

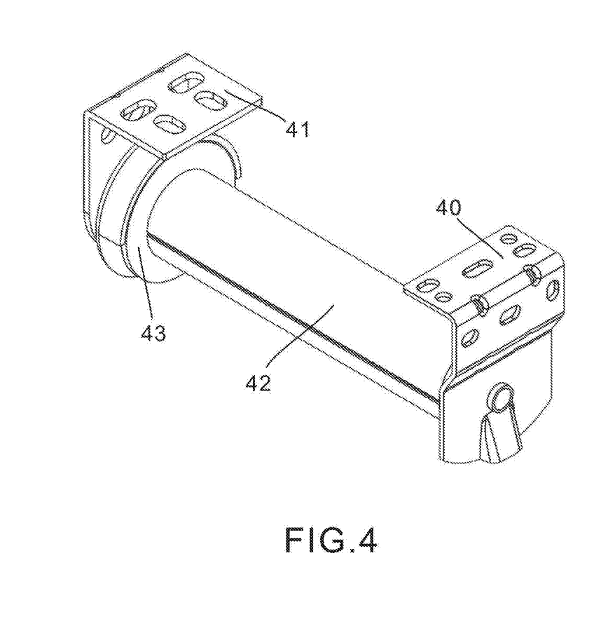

The shade sheet adjustment unit 4 (as shown in FIGS. 2, 3 and 4) includes two locating seats 40, 41 disposed on two sides of the fixing board 10 of the component fixing unit 1. The locating seats 40, 41 are positioned at the front end of the shade sheet winding unit 3 or the rear end thereof. The volume of the locating seats 40, 41 is slightly smaller than the volume of the holders 30, 31 of the shade sheet winding unit 3. A small-diameter roller 42 is mounted between the two locating seats 40, 41. The roller 42 is also controlled and driven by a bead chain controller 43 to rotate (as shown in FIG. 4).

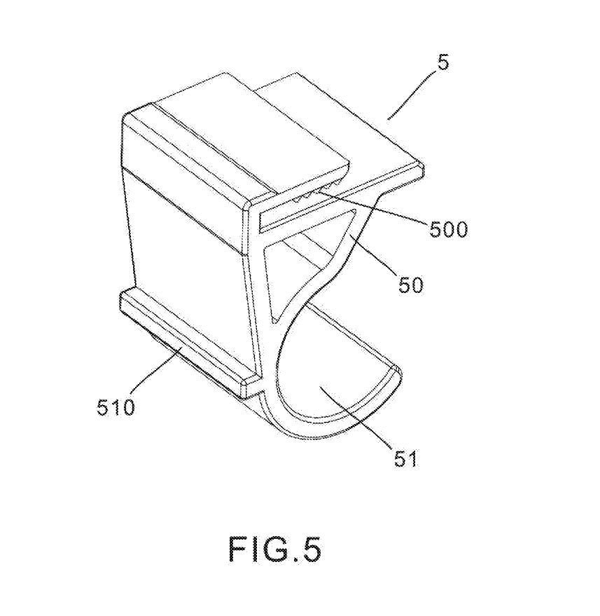

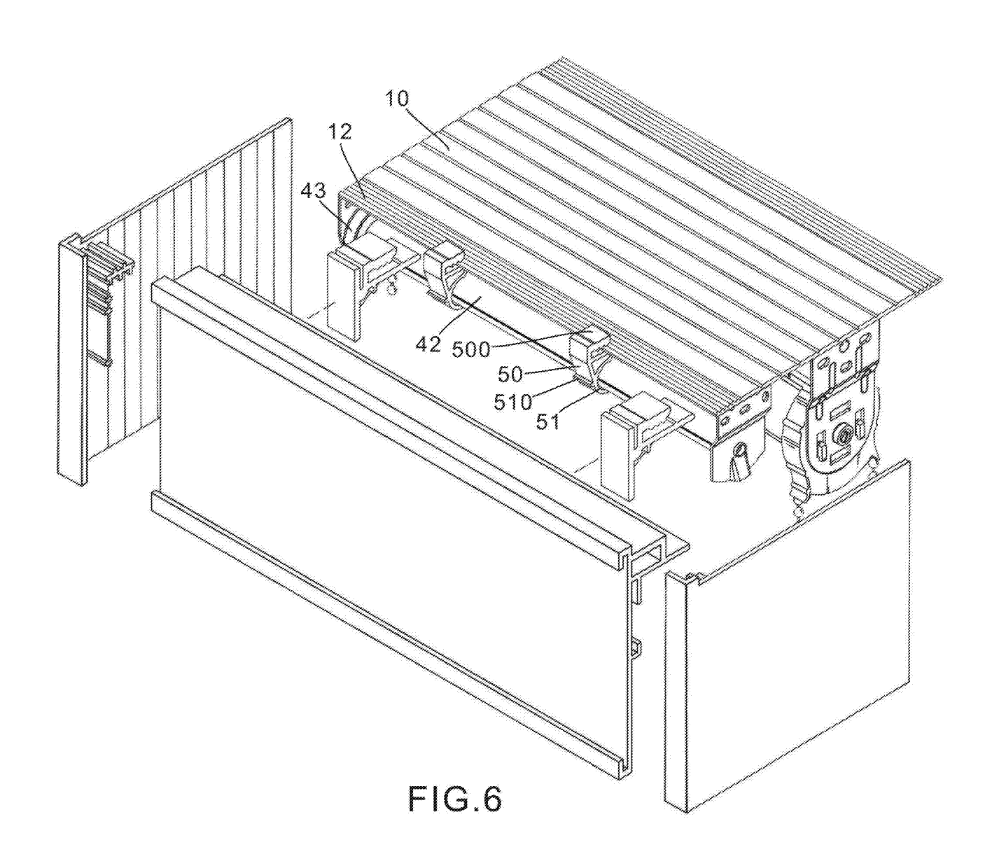

The support unit 5 (as shown in FIGS. 5 and 6) includes more than one support body 50. The upper end of the support body 50 has an engagement body 500 for engaging with the engagement teeth 12 of the fixing board 10 of the component fixing unit 1. The lower end of the support body 50 has an integrally extending arched recess 51. An abutment rib 510 is disposed at an outer end of the arched recess 51 and protrudes therefrom. The roller 42 of the shade sheet adjustment unit 4 is positioned in the arched recess 51 so as to keep the roller 42 in a straight state and prevent the roller 42 from downward curving due to its own length and weight. The roller 42 is driven by the bead chain controller 43 to rotate so as to truly adjust the rotational angle of the roller 42 and winding/unwinding length of the shade sheet (as shown in FIG. 6).

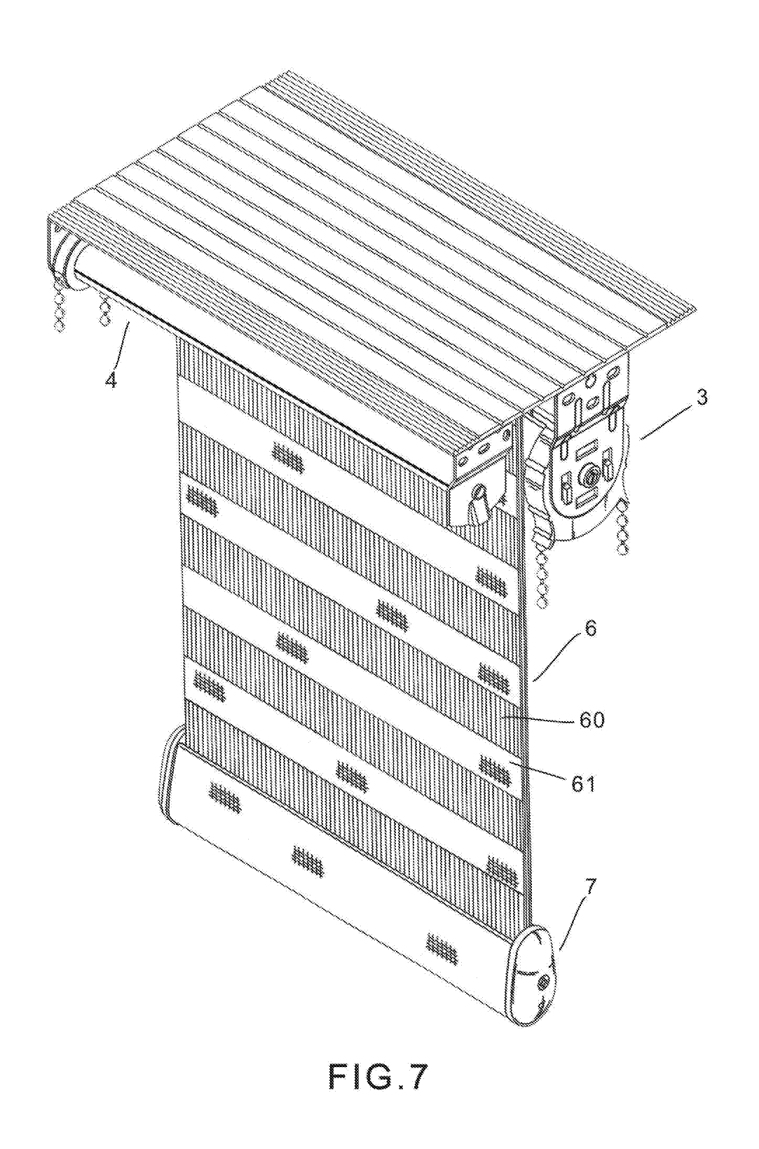

The shade sheet 6 (as shown in FIG. 7) is made of yarn material. The shade sheet 6 is formed with two kinds of sunshade yarn faces, that is, the transparent faces 60 and the nontransparent faces 61. The transparent faces 60 and the nontransparent faces 61 are alternately arranged. The shade sheet 6 is wound over the lower weight unit 7 and then two ends of the shade sheet 6 are respectively connected to the shade sheet winding unit 3 and the shade sheet adjustment unit 4.

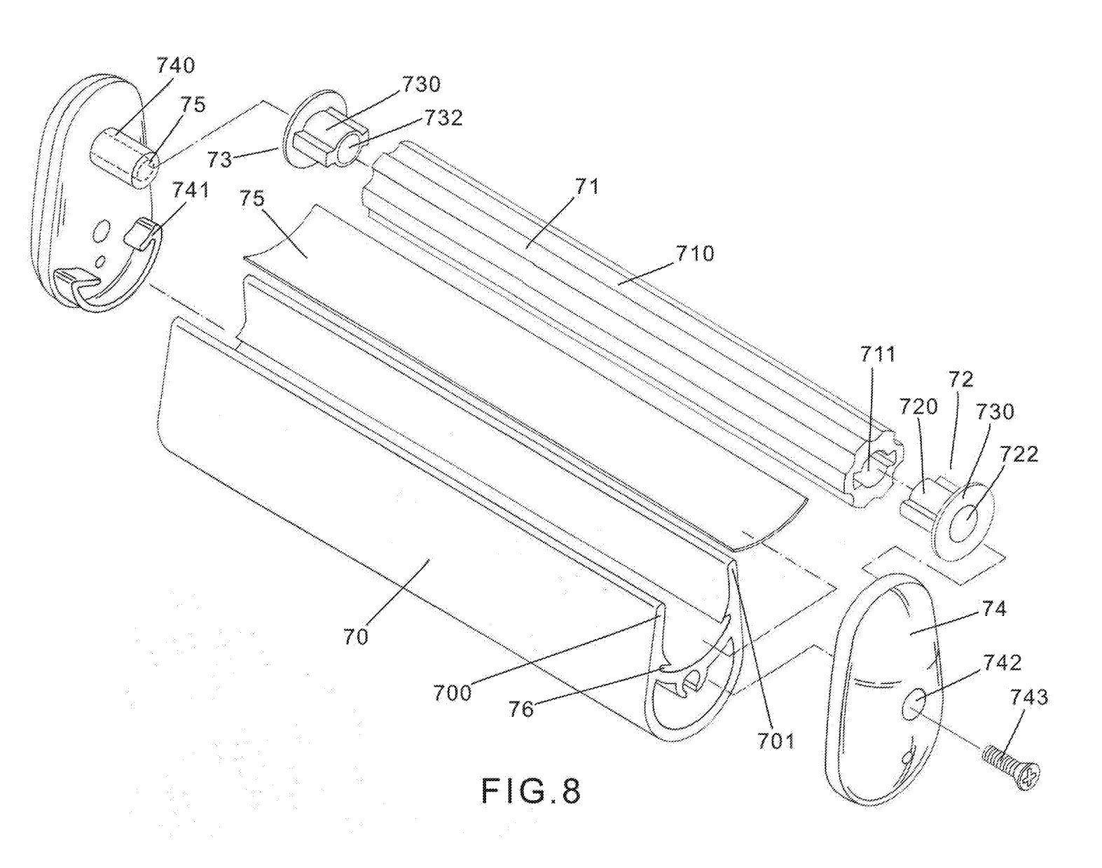

The lower weight unit 7 (as shown in FIG. 8) includes a main body 70, a drive shaft 71, two sleeves 72, 73, two side caps 74 and a locating plate 75. The outer circumference of the drive shaft 71 is formed with several splines 710. The drive shaft 71 is further formed with a central axial passage 711. Each sleeve 72, 73 has a boss 720, 730 at one end. The boss 720, 730 has a configuration identical to that of the passage 711. The bosses 720, 730 are directly fitted and connected in two ends of the passage 711. Each sleeve 72, 73 further has a disc section 721, 731 at the other end. A through hole 722, 732 is formed through the sleeve 72, 73 from the disc section 721, 731 to free end of the boss 720, 730. Each side cap 74 has a protruding circular post 740. The circular posts 740 of the side caps 74 are fitted in the through holes 722, 732, whereby the drive shaft 71 is rotatably located between the two side caps 74. A metal post 75 is enclosed in the circular post 740 for reinforcing the circular post 740. An insertion block 741 is disposed at the bottom end of the side cap 74 for engaging with the main body 70. The side cap 74 is further formed with a central perforation 742. A fastening screw 743 can be passed through the perforation 742 to integrally lock the side cap 74 with the main body 70. Two wall sections 700, 701 upward extend from the upper side of the main body 70 to define a space for receiving therein the drive shaft 71. A locating slot 76 is formed on the bottom of the space for the locating plate 75 to insert therein. The locating plate 75 is made of a flexible material and can be inserted into the locating slot 76 of the main body 70.

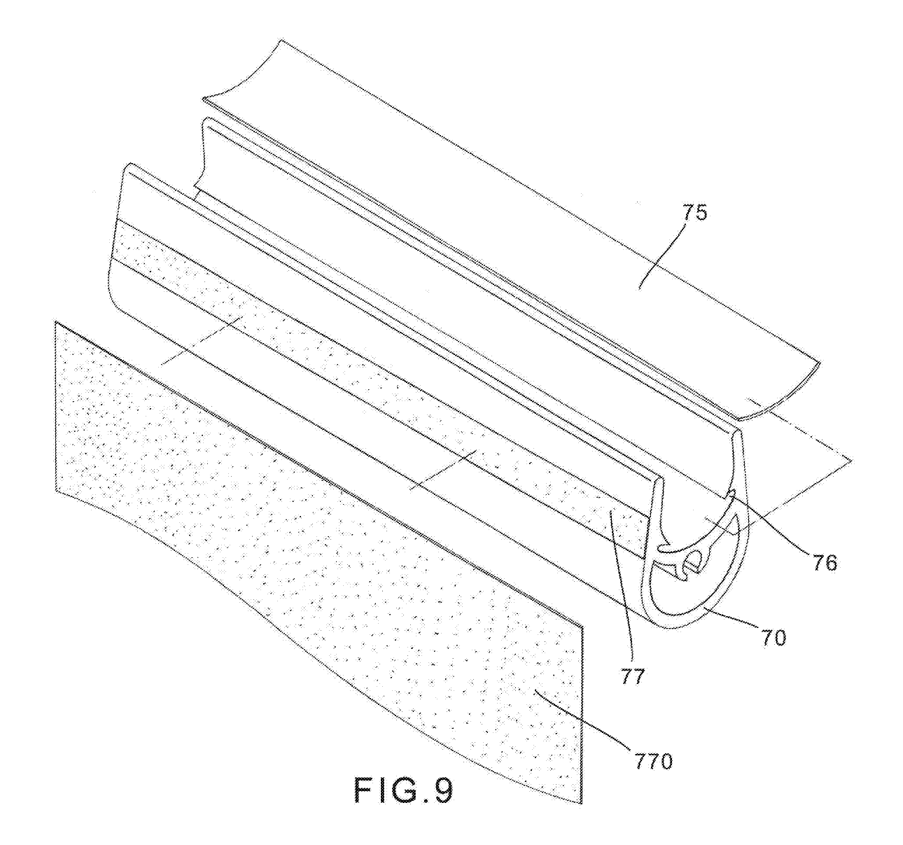

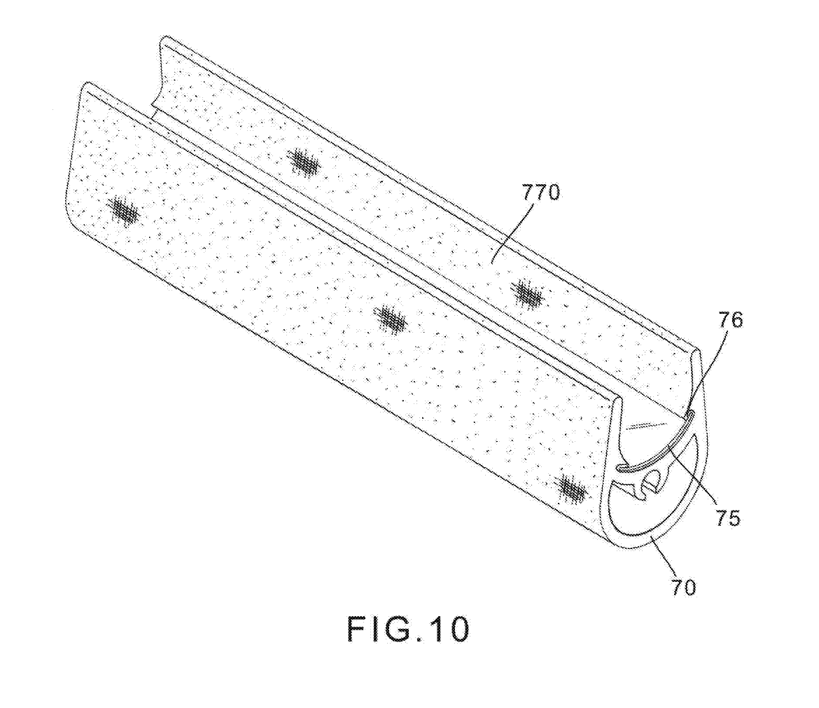

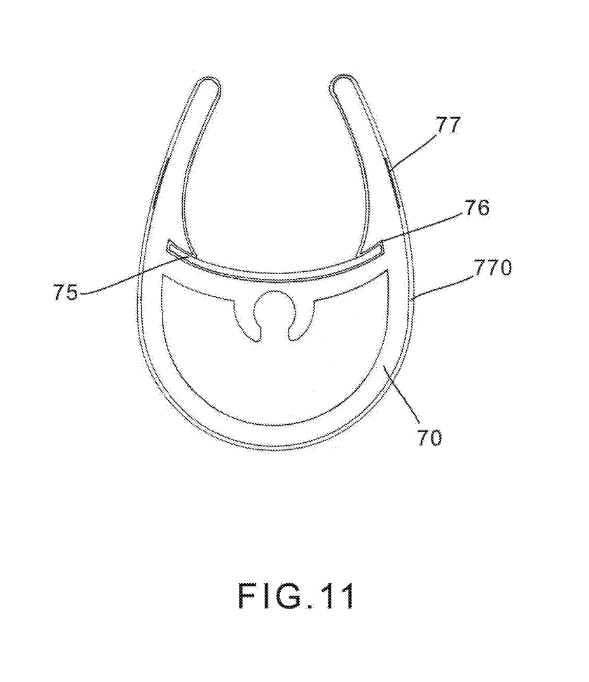

As shown in FIG. 9, when assembled, a shade sheet fabric 770 is first affixed to the surface of the lower weight by means of double-face adhesive tape 77 to wrap the lower weight. Thereafter, the locating plate 75 is inserted into the locating slot 76 for fully fixing the shade sheet fabric 770 to cover the lower weight (as shown in FIG. 10). Then, the two side caps 74 are locked on two sides of the main body 70 by means of the fastening screws 743. Under such circumstance, the drive shaft 71 is positioned in the space on the upper side of the main body 70 between the two wall sections 700, 701 to complete the entire lower weight structure (as shown in FIG. 11).

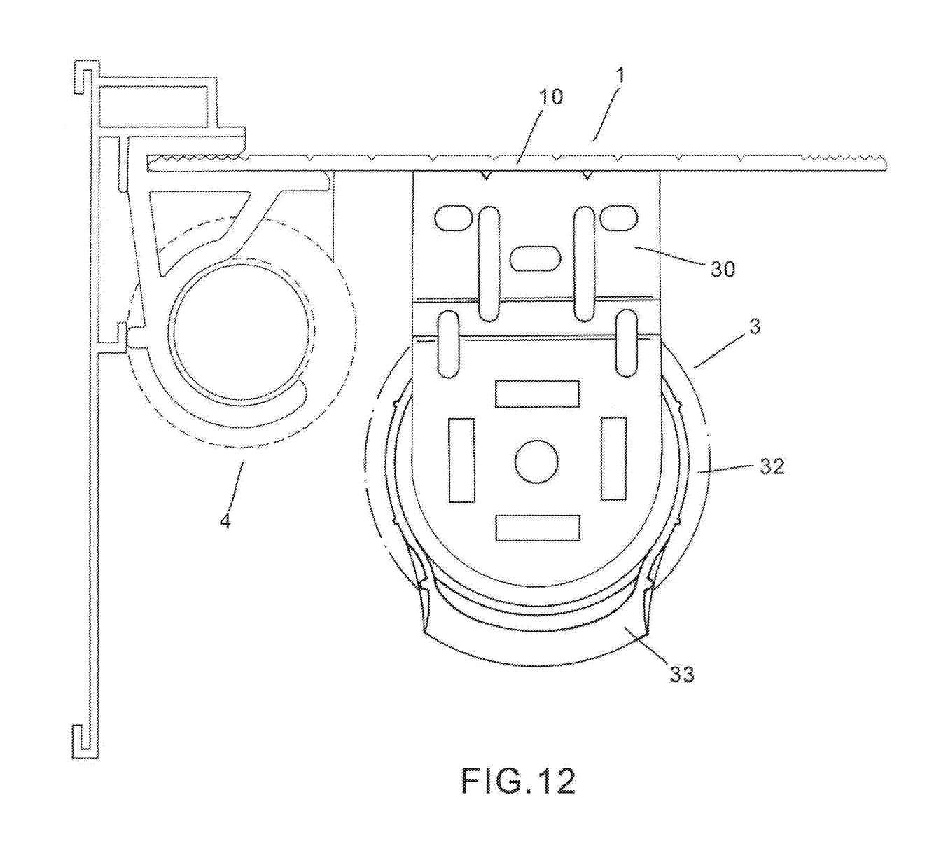

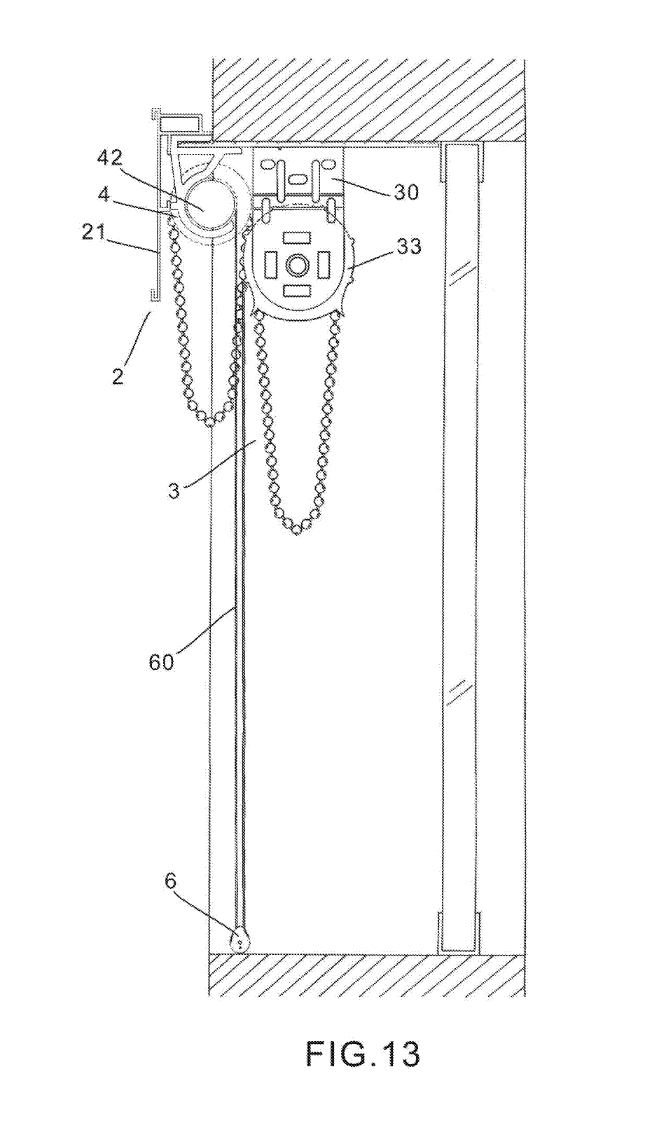

Referring to FIG. 12, the installation of the present invention is such that the shade sheet winding unit 3 and the shade sheet adjustment unit 4 are side by side and back and forth arranged under the fixing board 10 of the component fixing unit 1. Immediately thereafter, the fixing board 10 is locked under the upper wall face on inner side of the window by means of the fixing members with the engagement teeth 12 of the fixing board 10 protruding from the frame of the window (as shown in FIG. 13). In this case, the decorative board 21 can be located on the outer edge of the upper side of the window by means of the connection seats 200 of the decorative board locating unit 2 to cover the present invention and achieve a beautiful appearance. Finally, the shade sheet winding unit 3, the bead chain controller 33 and the roller 32 are mounted between the two holders 30, 31. One end of the shade sheet 60 is fixedly connected with the roller 32. The shade sheet 60 has transparent faces and nontransparent faces, which are alternately arranged. The other end of the shade sheet is wound over the lower weight 6 to fixedly connected to the roller 42 of the shade sheet adjustment unit 4 to complete the assembling process of the zebra shade (as shown in FIG. 13).

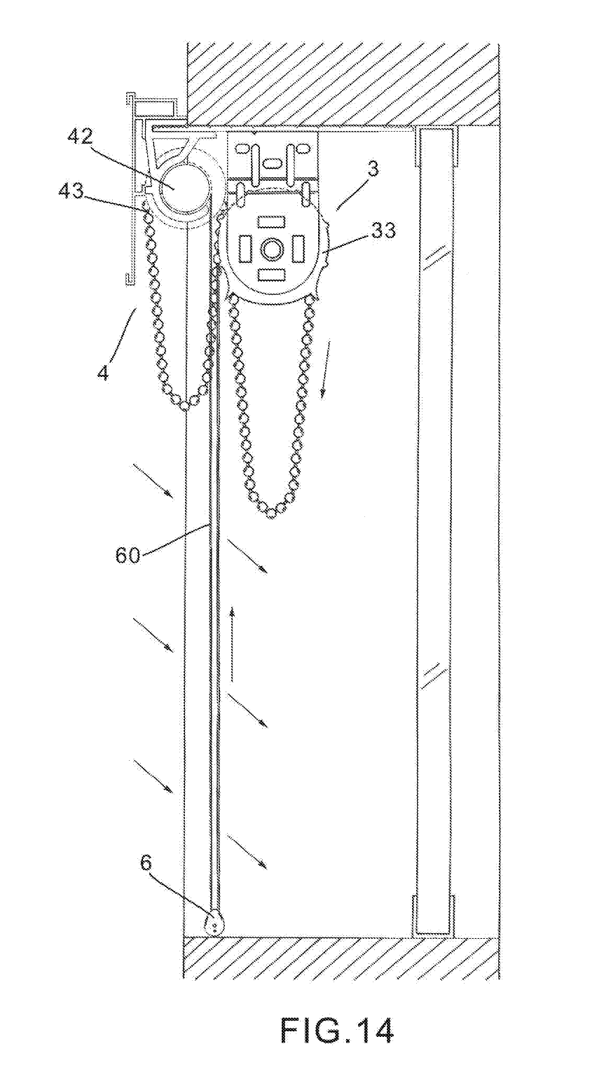

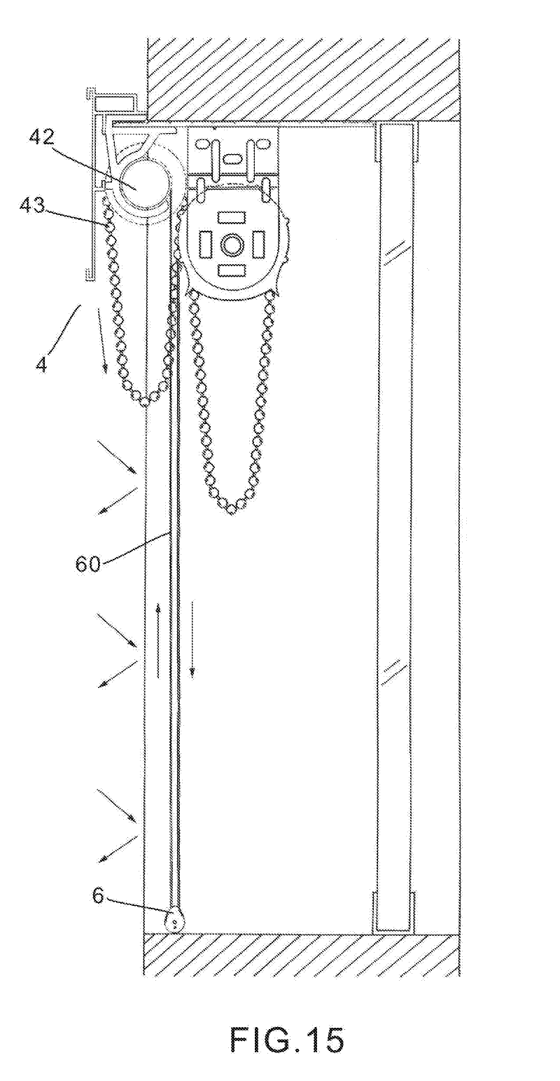

Referring to FIG. 14, the adjustment of the present invention is such that the bead chain controller 33 of the shade sheet winding unit 3 is used to control the roller 32 to clockwise or counterclockwise rotate, whereby the shade sheet 60 is upward wound or downward unwound. When it is desired to have the light, the transparent faces of the shade sheet are aligned with each other, permitting the sunlight to get in. When it is desired to shade the light, the transparent face and the nontransparent face of the shade sheet are aligned with each other to shade the sunlight. In the case that the transparent face and the nontransparent face are not precisely aligned with each other and there is a gap, the bead chain controller 43 of the shade sheet adjustment unit 4 is pulled to rotate the roller 42. The roller 42 has smaller diameter so that the shade sheet is adjusted by small angle to minify the gap or even eliminate the gap. Accordingly, the shade sheet can be micro-adjusted to minimize the gap and achieve better sun shading effect (as shown in FIG. 15).

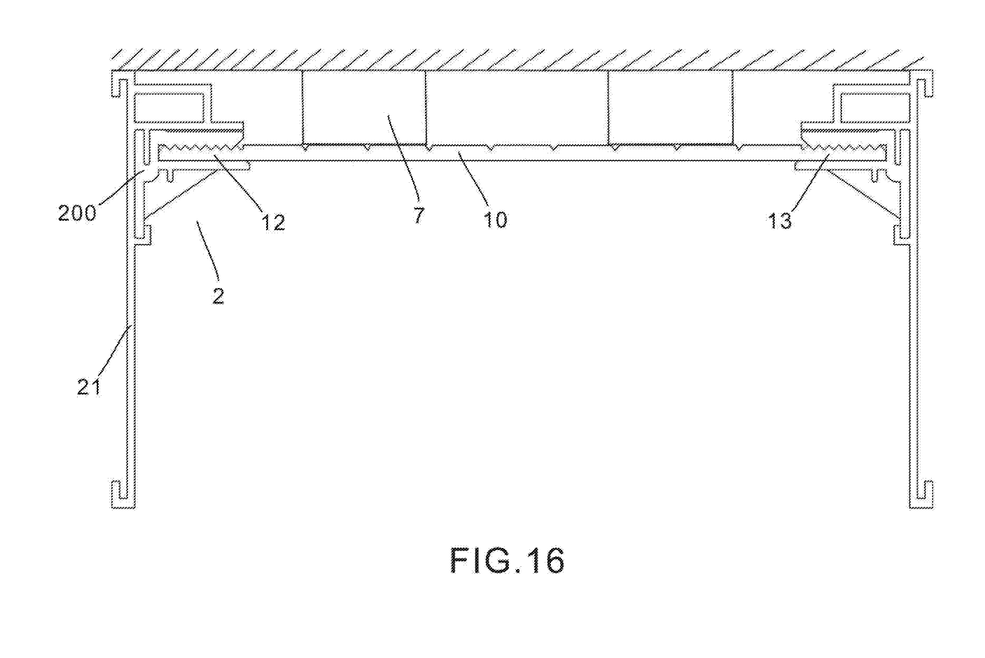

Please now refer to FIG. 16, which shows another embodiment of the present invention. In this embodiment, the decorative board locating unit 2 is mounted on inner window or outer window or arranged on both the front side and the rear side to enhance the tidiness and beautify the appearance of the shade sheet. More than one cellular separation body 7 is disposed on the fixing board 10, whereby the engagement teeth 12, 13 of the fixing board 10 are spaced from the wall face by a specific distance. In this case, the connection seats 200 of the decorative board locating unit 2 can be engaged on the engagement teeth 12, 13. Accordingly, the decorative boards 21 can be connected to both the inner window and a place in adjacency to the window to achieve a more beautiful appearance.

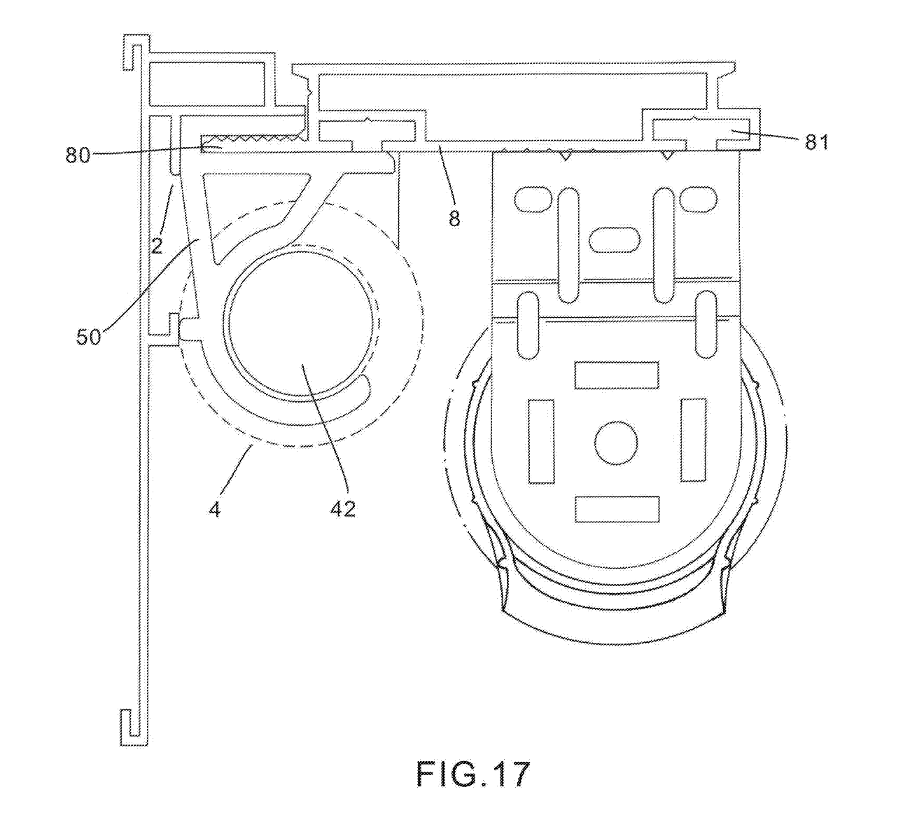

Please now refer to FIG. 17, which shows still another embodiment of the fixing board 8 of the component fixing unit 1 of the present invention. The front end of the fixing board 8 is formed with engagement teeth 80 and the rear end of the fixing board 8 is formed with an insertion channel 81. In the case that the shade sheet adjustment unit 4 is mounted on the front edge, the connection seat 200 of the decorative board locating unit 2 is engaged with the engagement teeth 80 and the support body 50 of the support unit 5 is also engaged with the engagement teeth 80 to support the roller 42 of the shade sheet adjustment unit 4. In the case that the shade sheet adjustment unit 4 is mounted on the rear edge, the engagement body of another type of support unit can be inserted in the insertion channel 81. The C-shaped arched recess of the lower end of the engagement body can hold and support the roller 42 of the shade sheet adjustment unit 4 to prevent the roller 42 from curving downward and keep the roller 42 straight. In this case, the adjustment can be more precisely performed.

The above embodiments are only used to illustrate the present invention, not intended to limit the scope thereof. Many modifications of the above embodiments can be made without departing from the spirit of the present invention.

What is claimed is:

1. A sun-shading adjustment structure of zebra shade, comprising:
a component fixing unit disposed on an upper wall face of inner side of a window, the component fixing unit including more than one fixing board, the fixing board having a front end and a rear end, the front end or the rear end of the fixing board being formed with engagement teeth;
a decorative board locating unit including more than one connection seat, the connection seat including a chucking mouth for engaging with the engagement teeth of the fixing board of the component fixing unit and an engagement board for connecting with a decorative board, the decorative board locating unit being connected with the decorative board and the fixing board of the component fixing unit;
a shade sheet winding unit disposed under the fixing board of the component fixing unit, the shade sheet winding unit including two holders disposed on two sides of the fixing board of the component fixing unit and a roller mounted between the two holders;
a shade sheet adjustment unit including two locating seats disposed on two sides of the fixing board of the component fixing unit, the locating seats being positioned at the front end of the shade sheet winding unit or the rear end thereof, the volume of the locating seats being slightly smaller than the volume of the holders of the shade sheet winding unit, a roller being mounted between the two locating seats, the roller being driven by a bead chain controller to rotate;
a shade sheet including a main body made of yarn material, the main body being formed with transparent faces and nontransparent faces, the transparent faces and the nontransparent faces being alternately arranged, two ends of the shade sheet being respectively connected to the shade sheet winding unit and the shade sheet adjustment unit, the shade sheet being wound over a lower weight unit to integrally connect therewith;
a lower weight unit including a main body and a drive shaft, the shade sheet being wound over a bottom section of the drive shaft, the drive shaft being rotatably located on two side caps by means of two sleeves, the two side caps being capped on two sides of the main body with the drive shaft positioned on upper side of the main body, the main body being formed with a locating slot, a flexible locating plate being inserted in the locating slot for fixing the shade sheet enclosing the surface of the main body; and
a support unit including an engagement body at upper end and an arched recess downward extending from the engagement body, the roller of the shade sheet adjustment unit being rotatably positioned in the arched recess, whereby the shade sheet winding unit serves to wind up the shade sheet to align the transparent faces and the nontransparent faces of the shade sheet with each other or misalign the transparent faces and the nontransparent faces of the shade sheet from each other so as to achieve a sun-shading effect, the shade sheet adjustment unit being further used to adjust the alignment error of the transparent faces and the nontransparent faces of the shade sheet so as to minimize the gap and enhance the sun-shading effect.

2. The sun-shading adjustment structure of zebra shade as claimed in claim 1, further comprising more than one cellular separation body disposed on the fixing board of the component fixing unit for spacing the fixing board spaced from the wall face of the window by a certain distance.

3. The sun-shading adjustment structure of zebra shade as claimed in claim 1, wherein the arched recess of the support unit is a C-shaped recess.

4. The sun-shading adjustment structure of zebra shade as claimed in claim 1, wherein the fixing board of the component fixing unit further includes a hollow board body, multiple engagement teeth disposed on a front end of the board body and protruding therefrom, and an insertion channel extending from a rear end of the board body.

5. The sun-shading adjustment structure of zebra shade as claimed in claim 1, wherein an abutment rib is further disposed at an outer end of the arched recess of the support unit.

6. The sun-shading adjustment structure of zebra shade as claimed in claim 1, wherein an engagement body is further disposed at an upper end of the arched recess of the support unit.

7. The sun-shading adjustment structure of zebra shade as claimed in claim 1, wherein the locating slot of the main body of the lower weight unit is an arched space.
